(19) United States
(12) Patent Application Publication
(10) Pub. No.: US 2017/0031905 A1
(43) Pub. Date: Feb. 2, 2017

(54) METHOD AND SYSTEM FOR CONTEXTUALIZED TOURNAMENT IMAGE AND VIDEO MANAGEMENT

(71) Applicant: Robert Thomas Boyer, Longmont, CO (US)

(72) Inventor: Robert Thomas Boyer, Longmont, CO (US)

(21) Appl. No.: 14/815,995

(22) Filed: Aug. 1, 2015

(51) Int. Cl. G06F 17/30

(52) U.S. Cl. CPC G06F 17/3028; G06F 17/30858; G06F 17/30864; G06F 17/30153; G06F 17/30604; G06F 17/30598

(57) ABSTRACT

An image-handling system for receiving and distributing images of a competitive event is provided. The image-handling system includes a storage system storing an image-handling routine, image data, and image mapping information and a processing system coupled to the storage system. The processing system, when executing the image-handling routine, is configured to receive and store images in the image data of the storage system, generate and store image mappings in the image mapping information of the storage system, with the image mappings correlating a particular image or images to a particular portion or portions of the competitive event, recall a image or images from the image data based on a received image request received from a requester, and transfer the requested image or images to the requester.

### TECHNICAL FIELD

The disclosure relates generally to a method and a system for providing effective and contextualized management of images and videos (including audio) of individual competitors and matches within competition brackets for large sporting events, and more particularly, to techniques for facilitating the gathering, contextualizing, and sharing of images and videos at large martial arts events.

### BACKGROUND

Sporting events are composed of many individual competitors, who are then gathered into different ages (e.g., 6-7 year olds), genders, skills (e.g., yellow belt), and weights (e.g., welter weight). Groups called brackets (aka divisions) are inherently difficult to manage. As a direct result, the acquisition and management of photos or videos within the context of these brackets has never been done.

At a typical tournament, professional photographers may take photos of the winners of each bracket. Often, wandering professional photographers take photos of random matches within the competition. Sometimes video is taken primarily for instant replay. Nearly always, parents and family take photos and videos of their children and friends. Such video and photographical data comprises a significant record of the proceedings, and is desired by event personnel, event participants, and many of the event spectators.

Yet for all the taking of pictures and video during the tournament, there is no flow of information in the form of these images or videos. There is no real-time gathering, organizing, or sharing of images or videos. After the tournament, the promoters will sometimes create a montage of images, often creating presentations in the form of videos and/or collected still photos, but such data is not systematically collected or distributed and only utilizes a fraction of the captured images or video.

### SUMMARY

An image-handling system for receiving and distributing images of a competitive event is provided. The image-handling system includes a storage system storing an image-handling routine, image data, and image mapping information and a processing system coupled to the storage system. The processing system, when executing the image-handling routine, is configured to receive and store images in the image data of the storage system, generate and store image mappings in the image mapping information of the storage system, with the image mappings correlating a particular image or images to a particular portion or portions of the competitive event, recall an image or images from the image data based on a received image request received from a requester, and transfer the requested image or images to the requester.

An image-handling method for receiving and distributing images of a competitive event is provided. The image-handling method includes an image handling system receiving and storing images in image data of a storage system, the image handling system generating and storing image mappings in image mapping information of the storage system, with the image mappings correlating a particular image or images to a particular portion or portions of the competitive event, the image handling system recalling an image or images from the image data based on a received image request received from a requester, and the image handling system transferring the requested image or images to the requester.

### BRIEF DESCRIPTION OF THE DRAWINGS

Advantages of the disclosed techniques may become apparent upon reading the following detailed description and upon reference to the drawings.

FIG. 1 shows an image handling system in one embodiment.

FIG. 2 is a flowchart of an image-handling method for receiving and distributing images of a competitive event in one embodiment.

FIG. 3 shows an example bracket display generated on a computerized device.

FIG. 4 shows a match result display generated on a computerized device.

FIG. 5 shows an image upload display generated on a computerized device.

FIG. 6 shows a video upload display generated on a computerized device.

FIG. 7 shows an event-related upload display generated on a computerized device.

FIG. 8 is a flowchart of a method for showing images in an image data of the image handling system.

FIG. 9 is a flowchart of a method for uploading images or videos from a user device, such as a user computer device.

FIG. 10 is a flowchart of a method for uploading videos to the Internet.

FIG. 11 is a flowchart of a method for showing videos stored by the image handling system.

FIG. 12 is a flowchart of a method for uploading videos from a user's computer or computerized device.

### DETAILED DESCRIPTION

The following description and associated drawings teach the best mode of the invention. For the purpose of teaching inventive principles, some conventional aspects of the best mode may he simplified or omitted. The following claims specify the scope of the invention. Some aspects of the best mode may not fall within the scope of the invention as specified by the claims. Thus, those skilled in the art will appreciate variations from the best mode that fell within the scope of the invention. Those skilled in the art will appreciate that the features described below can be combined in various ways to form multiple variations of the invention. As a result, the invention is not limited to the specific examples described below, but only by claims and their equivalents.

An image handling method and system is described for receiving and distributing images of a competitive event. The image handling method and system facilitate the gathering and assembling of images of the competitive event. The image handling method and system facilitate the obtaining of images of the competitive event. The image handling method and system facilitate the organizing and storing of images of the competitive event. The image handling method and system facilitate supplying images to persons requesting images of the competitive event.

Persons can find images of a specific portion or portions of the competitive event using the image handling method and system. Persons can request images of a specific portion or portions of the competitive event using the image handling method and system.

Persons can find images of a specific portion or portions of the competitive event by specifying participant information. Persons can find images of a specific portion or portions of the competitive event by specifying match information. Persons can find images of a specific portion or portions of the competitive event by specifying presentation information. Persons can find images of a specific portion or portions of the competitive event by specifying weight class information, age class, gender, and/or skill level (e.g., belt rank), for example. Persons can find images of a specific portion or portions of the competitive event by specifying division information. Persons can find images of a specific portion or portions of the competitive event by specifying bracket information. Persons can find images of a specific portion or portions of the competitive event by specifying schedule information.

An image and video management method and system is described that provides for real-time acquisition, contextualization, and sharing of images and videos.

In one embodiment, competitor brackets are displayed to tournament personnel and spectators which contain specific hyper-links associated with each match or presentation. Following the link from the bracket overview causes the user to be presented with a separate area detailing the context of the activity. The user then uploads images or video directly in context of the activity to which the image or video applies.

In another embodiment, the user is allowed, through a series of drop-downs, manual entry, or other mechanisms, to directly identify the context of the data to be provided into the system.

In another embodiment, file transfers of the images or videos are made to specific computer directories, whose organizational structure provides the specific context of the activity. The user performing the upload has a specific mapping, such as tournament ID/division ID/match ID into which to store the associated data.

In one embodiment having identified, through one of the above mechanisms, the context for the data, the user may start a video recording that “uploads” as it is recording, with the contextual knowledge of where it is stored and what it related to being stored within the system.

In one embodiment, images and videos are stored based on a specific file structure. In another embodiment, images and videos may reside (be stored) anywhere, either on the primary system itself a common video server, or anywhere else accessible on the web, with the storage location knowledge discoverable within the primary system, such as a local database. In another embodiment, images and videos are stored in the context not of their specific activity, but abstracted one or more levels ‘higher’, e.g., by bracket or event.

In some embodiments, a person providing the images or videos is given the opportunity to add titles or captions which are later displayed to the information consumers. In some embodiments, thumbnail views of the images or videos are presented adjacent to where uploading of new images may occur. Clicking on the thumbnail then presents a full-sized version of the image, or plays an audio recording, or plays the associated video.

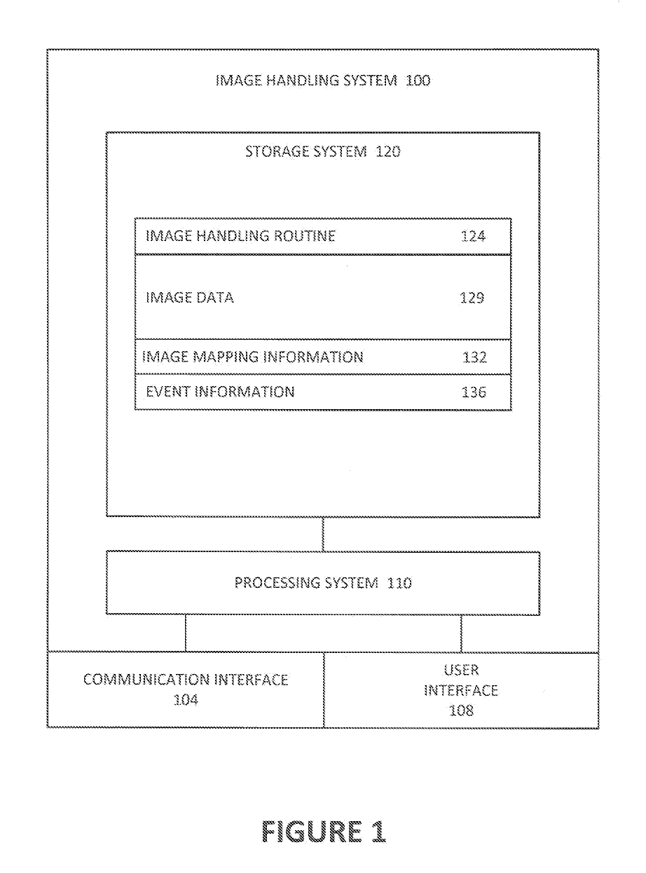

FIG. 1 shows an image handling system 100 in one embodiment. The image handling system 100 includes a communication interlace 104, a user interface 108, a storage system 120, and a processing system 110. The processing system 110 is coupled to the communication interface 104, the user interface 108, and the storage system 120.

The storage system 120 stores an image handling routine 124 that, when executed by the processing system 110, configures the processing system 110 to perform image handling, as discussed below in relation to any of the embodiments disclosed herein. The storage system 120 further stores image data 129, image mapping information 132, and event information 136.

The image handling routine 124 comprises machine-readable instructions that control the operation of the processing system 110 when executed by the processing system 110. The image handling routine 124 may also include operating systems, applications, utilities, databases, and the like. All or portions of the image handling routine 124 (and other data) may be externally stored on one or more storage media, such as flash drives, discs, servers, and the like. The image handling routine 124 in the examples comprises computer programs, firmware, or some other form of machine-readable processing instructions. The image handling routine 124 may include an operating system, utilities, drivers, network interfaces, applications, virtual machines, or some other type of software. The image handling routine 124 can include additional processes, programs, or components, such as operating system software, database software, or application software. The image handling routine 124 can also comprise firmware or some other form of machine-readable processing instructions executable by the processing system 110.

The image data 129 comprises images, including still images and/or video images, including digital video that comprises sequences of images. The image data 129 comprises images of the competitive event. Alternatively, or in addition, the image handling system 100 is coupled to one or more external storages or databases (not shown) that store all or part of the image data 129.

The image data 129 comprises images taken by one or more persons using one or more image capturing/recording devices. The image data 129 can be captured by professional photographers or videographers. The image data 129 can be captured by event personnel, including referees, judges, or other image personnel. The image data 129 can be captured by event participants. The image data 129 can he captured by spectators, including friends and family of event participants, for example. The image data 129 can comprise a combination of image data contributed by one or more of provisional photographers or videographers, event personnel, event participants, and spectators.

The image data 129 comprises images related to the competitive event. The image data 129 comprises a collection of images, wherein the images comprise images of various matches, presentations, brackets, and/or divisions of the competitive event. In some embodiments, the image data 129 includes images for various matches and/or presentations of the competitive event. The image data 129 therefore can include images for various matches and/or presentations for various weight classes, age classes, genders, skill levels, brackets, and/or divisions of the competitive event.

The image data 129 can comprise still images of a single image type or single image format, such as still images of a .jpg format .bmp format, .tff format, et cetera. The image data can include video images of a single video type or single video format such as videos of a .mpg format, .mpg4 format, .avi format, et cetera. Alternatively, the image data 129 can comprise images of various formats, depending on the sources of the various images. In some embodiments, the image handling system 100 converts received images into preferred still and video image formats for storage. Alternatively, the image handling system 100 stores images in the format received and is capable of converting images to other image formats upon request, such as into image formats requested by the persons who are requesting images from the image handling system 100.

The image data 129 can include images captured at different activity areas of the competitive event. The image data 129 can include images captured at different times during the competitive event. The image data 129 can include images captured for different matches of the competitive event. The image data 129 can include images captured for different presentations of the competitive event. The image data 129 can include images captured for different weight divisions of the competitive event. The image data 129 can include images captured for different age classes of the competitive event. The image data 129 can include images captured for different genders of the competitive event. The image data 129 can include images captured for different skill levels of the competitive event. The image data 129 can include images captured tor different divisions of the competitive event. The image data 129 can include images captured for different brackets of the competitive event.

The image mapping information 132 comprises information that maps or otherwise organizes the image data to a particular set of relationships with the participants. In some embodiments, the image mapping information 132 organizes and/or indexes the images within the image data 129 based on club affiliation, organization affiliation, slate represented, and/or country by the athlete/participant.

The image mapping information 132 can map an image or images to a particular activity area of the competitive event. The image mapping information 132 can map an image or images to a particular time of the competitive event The image mapping information 132 can map an image or images to a particular match or matches of the competitive event. The image mapping information 132 can map an image or images to a particular presentation or presentations of the competitive event. The image mapping information 132 can map an image or images to a particular weight class or classes of the competitive event. The image mapping information 132 can map an image or images to a particular division or divisions of the competitive event. The image mapping information 132 can map an image or images to a particular bracket or brackets of the competitive event.

The event information 136 comprises information about the competitive event that can he used by the image handling system 100 to generate the image mapping information 132. The event information 136 in some embodiments includes competitor information, school/club affiliation, age, skill level and other or additional information. The image mapping information 132 is used by the image handling system 100 to organize the image data 129 in some embodiments. The image mapping information 132 is used by the image handling system 100 to index the image data 129 in some embodiments.

In some embodiments, the event information 136 further includes information such as an event ID or other event information, event sponsors, event logos, and others. Further, the event information 136 in some embodiments includes competitor statistics, competitor rankings, competitor histories, competitor club and organization affiliations. The event information 136 can include information about each division and bracket entered or competing in the competitive event.

When the competitive event has began (or has been completed), the event information 136 can include additional information. The additional information can include, for example, matches and/or presentations that have been completed, match or presentation results, competitor scores, competitor rankings, and other information. It should be understood that the above listing is not exhaustive. Other or additional event information is within the scope of the description and claims.

The event information 136 in some embodiments includes participant information of the competitive event. The event information 136 in some embodiments includes match information of the competitive event. The event information 136 in some embodiments includes presentation information of the competitive event. The event information 136 in some embodiments includes weight class information of the competitive event. The event information 136 in some embodiments includes division information of the competitive event. The event information 136 in some embodiments includes bracket information of the competitive event. The event information 136 in some embodiments includes schedule information of the competitive event.

When executed by the processing system 110, the image handling routine 124 directs the image handling system 100 to receive and store images in the image data 129 of the storage system 120, generate and store image mappings in the image mapping information 132 of the storage system 120, with the image mappings correlating a particular image or images to a desired portion or portions of the competitive event, recall a image or images from the image data 129 based on a received image request, and transfer the requested image or images to a requester. As a result, the requester can access the requested image or images for a desired portion or portions of the competitive event. Consequently, the image handling routine 124 configures the processing system 110 to recall the image or images from the image data 129 based on the received image request and based on the event information 136.

In some embodiments, the image handling routine 124 further configures the processing system 110 to perform image format conversion on received or requested images. In some embodiments, the image handling routine 124 further configures the processing system 110 to adjust image size or image characteristics of received or requested images. In some embodiments, the image handling routine 124 further configures the processing system 110 to perform image enhancement on received or requested images. In some embodiments, the image handling routine 124 further configures the processing system 110 to perform compression on a received or requested images. In some embodiments, the image handling routine 124 further configures the processing system 110 to recall the image or images from the image data based on the received image request and based on the event information. In some embodiments, the image handling routine 124 further configures the processing system 110 to request images from one or more of event personnel, event participants, and event spectators. In some embodiments, the image handling routine 124 further configures the processing system 110 to perform one or both of organizing the image data or indexing the image data.

The image handling system 100 comprises a computerized device. The image handling system 100 comprises a portable image handling system 100 in some examples. The image handling system 100 comprises a wireless image handling system 100 in some examples. The image handling system 100 can comprise a mobile device, including a cellular phone, but also may include other devices, such as subscriber equipment, customer equipment, an access terminal, a smartphone, a telephone, a mobile wireless telephone, a personal digital assistant (PDA), a computer, an e-book, a mobile Internet appliance, a wireless network interface card, a media player, a game console, or some other communication, apparatus, including combinations thereof. The image handling system 100 may be integrated within other systems and devices, such as competitive event devices, networks, or systems, or can be integrated within vehicles, appliances, apparel and the like.

The communication interface 104 sends and receives data and/or messages. The communication interface 104 is configured to exchange communications between the image handling system 100 and external devices, communication networks, and/or other systems. The communication interface 104 is configured to exchange communications between the image handling system 100 and electronic devices of event personnel, event participants, and event spectators, for example. The communication interface 104 in some examples is configured to communicate with competitive event devices, networks, or systems. The communication interface 104 exchanges the image data 129, including receiving images to be included in the image data 129. The communication interface 104 can further transmit or transfer images (or copies of images) from the image data 129 to other devices or destinations. The communication interface 104 receives the event information 136 in some examples.

The communication interface 104 in some examples wirelessly exchanges communications. Alternatively, or in addition, the communication interface 104 exchanges communications over a communication medium, including wires, cables, fibers, or other suitable communication medium.

The communication interlace 104 comprises communication components, such as ports, signal processing circuitry, memory, software, and the like. The communication interface 104 in the examples comprises a network card, network interface, port, or interface circuitry that allows the image handling system 100 to communicate with other devices or systems over a variety of networks. The communication interface 104 may also include a memory device, software, processing circuitry, or some other device. The communication interface 104 may use various communication protocols to exchange communications.

The user interface 108 comprises one or both of user input devices and user output devices. The user interface 108 in some examples comprises one or more input devices for receiving user inputs, including keyboards, pointing devices, touch screens or touch sensors, audio inputs, or other input receiving/generating devices. The user interface 108 receives user inputs in some examples, with the user inputs directing the image handling system 100 to receive an image or images from the user and/or receives user inputs requesting an image or images from the image handling system 100.

The user interface 108 in some examples includes one or more output devices, including displays, touch screens, printers, speakers, or other output generating devices. The one or more output, devices output information to a user or users of the image handling system 100, including communicating a requested image or images to a requester.

The processing system 110 comprises one or more microprocessors and other circuitry that retrieves and executes the image handling routine 124. The processing system 110 in some examples comprises circuit boards, integrated circuitry, and associated electronics. The processing system 110 can be implemented within a single processing device but can also he distributed across multiple processing devices or sub-systems that cooperate in executing program instructions. Examples of the processing system 110 include general purpose central processing units, application specific processors, and logic devices, as well as any other type of processing device, combinations, or variations thereof. In some examples, the processing system 110 includes a computer readable storage media capable of storing the image handling routine 124. The processing system 110 can include volatile and nonvolatile, removable and non-removable media implemented in any method or technology for storage of information, such as computer readable instructions, data structures, program modules, or other data.

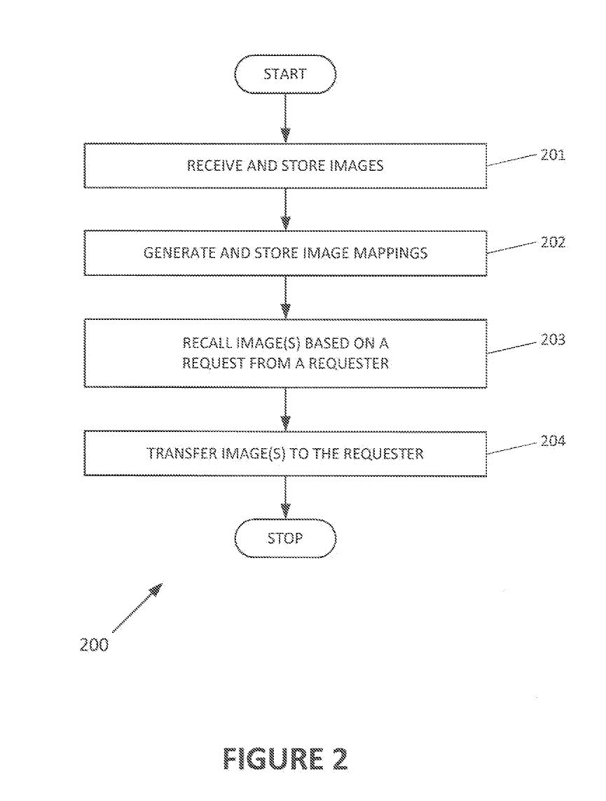

FIG. 2 is a flowchart 200 of an image-handling method for receiving and distributing images of a competitive event in one embodiment. In some embodiments the method is performed by an image handling system, for example. In step 201, an image handling system receives and stores images in image data of a storage system. The images comprise images a portion or portions of the competitive event.

In step 202, the image handling system generates and stores image mappings in image mapping information of the storage system. The image mappings correlate a particular image or images to a particular portion or portions of the competitive event. For example, the image mappings can correlate a particular image or images to the participant information of the competitive event. The image mappings can correlate a particular image or images to match information of the competitive event. The image mappings can correlate a particular image or images to the presentation information of the competitive event. The image mappings can correlate a particular image or images to the weight class information of the competitive event. The image mappings can correlate a particular image or images to the age class information of the competitive event. The image mappings can correlate a particular image or images to the gender information of the competitive event. The image mappings can correlate a particular image or images to the skill level information of the competitive event. The image mappings can correlate a particular image or images to the division information of the competitive event. The image mappings can correlate a particular image or images to the bracket information of the competitive event. The image mappings can correlate a particular image or images to the schedule information of the competitive event.

In step 203, the image handling system recalls an image or images from the image data, based on a received image request received from a requester. The requester can request a specific image or sequence of images, including requesting video. The requester can request an image or images based on a specific portion or portions of the competitive event. The requester can request an image or images based on a participant or participants of the competitive event. The requester can request as image or images based on a match or matches of the competitive event. The requester car request an image or images based on a presentation or presentations of the competitive event. The requester can request an image or images based on a weight class or classes of the competitive event. The requester can request an image or images based on an age class or classes of the competitive event. The requester can request an image or images based on a gender of the competitive event. The requester can request an image or images based on a skill level or levels of the competitive event. The requester can request an image or images based on a division or divisions of the competitive event. The requester can request an image or images based on a bracket or brackets of the competitive event. The requester can request an image or images based on a schedule of the competitive event. It should be understood that the above listing is not exhaustive, lire request can be based on other or additional characteristics of the competitive event, and the other or additional characteristics are within the scope of the description and claims.

In step 204, the image handling system transfers the requested image or images to the requester. The requester can view the image or images on an electronic device. The requester can save the image or images on the electronic device. The requester can transfer the image or images to other electronic devices and/or to other persons.

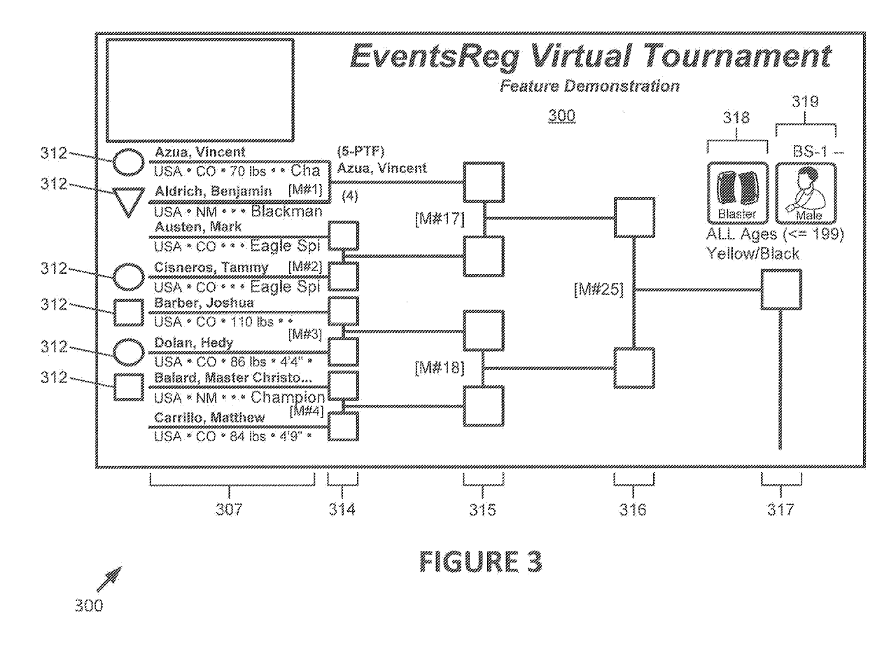

FIG. 3 shows an example bracket display 300 generated on a computerized device. The computerized device can comprise a device of event personnel, an event participant, or an event spectator in some examples. The computerized device can comprise a laptop, tablet, smartphone, cellphone, personal digital assistant, or other computerized device able to exchange electronic communications and/or display electronic images. The bracket display 300 shows at least a partial bracket or a competitive event. The bracket display 300 in the example shown includes an event participant listing 307, first bracket result boxes 314, second bracket result boxes 315, third result bracket result boxes 316, and a fourth (and final) result bracket result boxes 317. In addition, the bracket display 300 in some embodiments includes a competition type graphic 318 and a gender graphic 319. Each event participant listing 307 includes a contestant name and contestant information (country, state, weight class, height school, or organization affiliation, for example). Each event participant listing 307 can be associated with a school or organization emblem or logo 312, such as a taekwondo emblem or logo 312. In some embodiments, selecting the [M#xx] in the event participant listing 307 takes the display 300 to a page or display that presents match information.

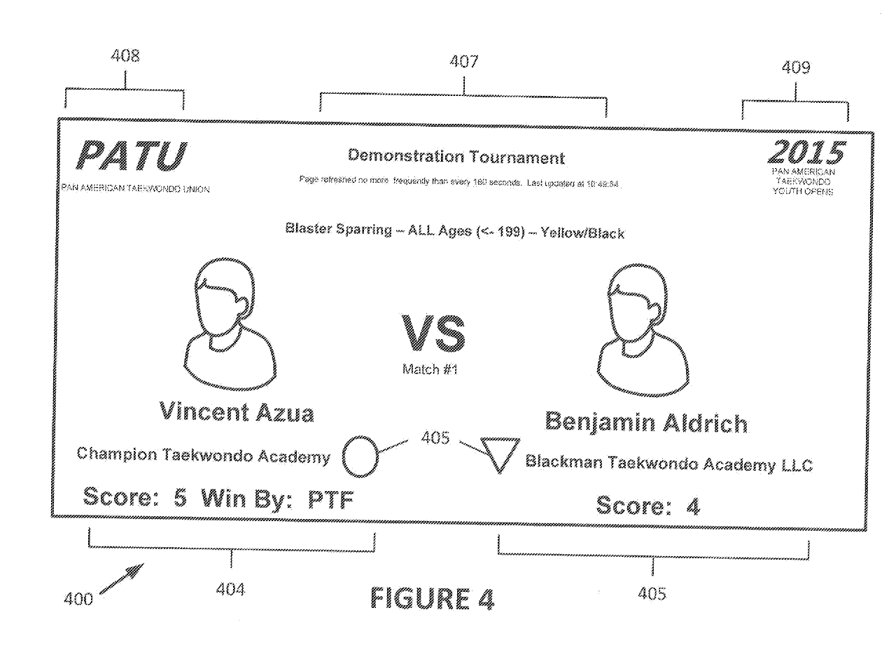

FIG. 4 shows a match result display 400 generated on a computerized device. The match result display 400 displays a potential matchup and/or displays a match result. Alternatively, or in addition, the match result display 400 shows the context of what the images or videos will be associated to. In this case, the match is already completed as shown by the scores. For an active match, the scores would not be present. The match result display 400 can be used by event personnel, event participants, and/or event spectators. The match result display 400 in the embodiment shown includes a first contestant display 404, a second contestant display 405, an organizational graphic 408, a match informational information 407, and a date graphic 409. The first contestant display 404 and the second contestant display 405 display contestant information, for a specific match, including contestant name, contestant school or organizational information (including a school or organization emblem or logo 412), and score or result information. The organizational graphic 408 includes organizational information, such as a sponsoring or sanctioning body, for example. The match information 407 includes a match type or category, a gender, a match age class, a match weight class, a belt or skill level, or any other relevant information. The date graphic 409 can include an event year, month, or other date information, including an event type or sponsorship, for example.

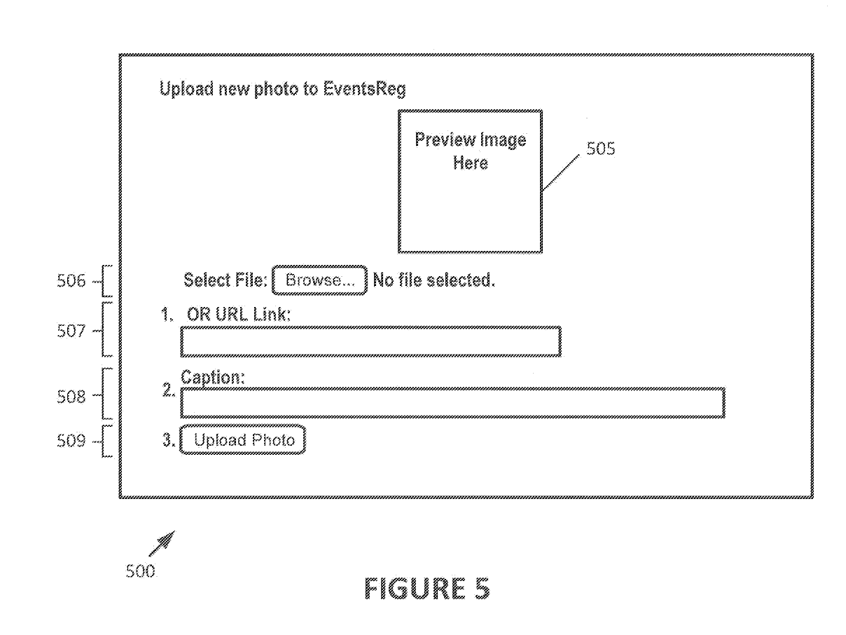

FIG. 5 shows an image upload display 500 generated on a computerized device. The image upload display 500 displays an upload page or screen for uploading images to an image handling system. The image upload display 500 can be used by event personnel photography or videography personnel, event participants, and/or event spectators.

The image upload display 500 in some embodiments performs a file upload to an event computer, network, or server, or allows for the identification of a location on the web. It shows a preview of the image to be associated and allows for entry of a caption (e.g., “Great Head Kick by Johnny!”). The image upload display 500 in the embodiment shown includes an image viewing area 505, a file select area 506, a URL select area 507, a caption entry area 508, and. an upload selection area 509. The image viewing area 505 can display a thumbnail or small image as part of the upload process. Further, the image viewing area 505 can display a portion or all of a video in some embodiments. The image viewing area 505 can be consulted by the user to ensure that the user is uploading an image or images that the user intends to upload. The file select area 506 can be employed by the user to specify or select a file to be uploaded, such as by selecting a tile from a list or by following a file tree to find a particular file. The URL select area 50 can be employed by the user to select a image or images by entering or selecting an appropriate URL (Uniform Resource Locator) or other link, address, or network information. The caption entry area 508 can be employed by the user to generate or enter a caption for the image or images being uploaded. The upload selection area 509 in the embodiment shown comprises a button, selection graphic, or other input area that can be employed by the user to finalize an image upload, such as when other items of information have been specified or completed.

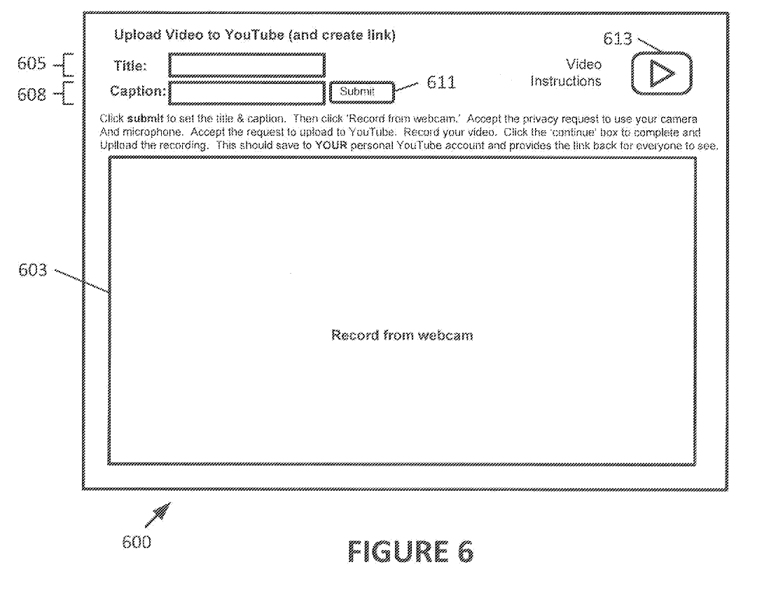

FIG. 6 shows a video upload display 600 generated on a computerized device. The video upload display 600 displays an upload page or screen for uploading video to an image handling system. The video upload display 600 can be used by event personnel, photography or videography personnel, event participants, and/or event spectators.

The video upload display 600 in some embodiments performs a recording directly from the user's device (e.g., smartphone) to YouTube. The instructions indicate how this works. The video upload display 600 in the embodiment shown includes a video display area 603, a title entry area 605, a caption entry area 608, a submit button 611, and a video play button 613. The video display area 603 can display at least a portion of video being uploaded through the video upload display 600. The title entry area 605 can be employed by the user to enter a title (or name) of the video to be uploaded. The caption entry area 608 can be employed by the user for entering a caption to be stored with and associated with the video to he uploaded. The submit button 611 can be employed by the user for uploading the video when the user has specified the video. The submit button 611 can be used to initiate the video upload process. The video play button 613 can be employed by the user to play the video. The selected video can be played in the video display area 603 when the video play button 613 has been selected/actuated. The user can select the video play button 613 to play the video before, during, or after the uploading process, for example. The user can select the video play button 613 to play the video in order to verify the video has been selected, or to verify that the video is the correct video.

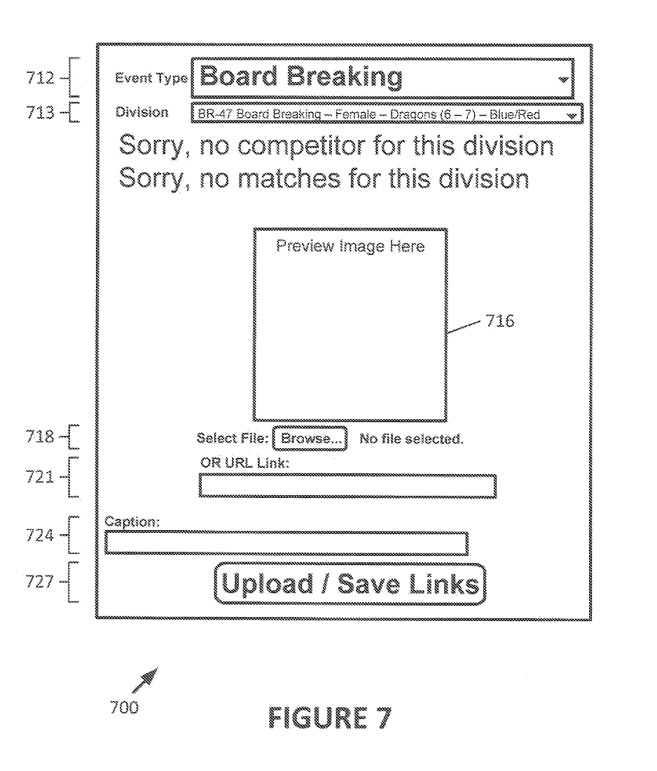

FIG. 7 shows an event-related upload display 700 generated on a computerized device. The event-related upload display 700 displays an upload page or screen for uploading images by specifying event-related information. The event-related upload display 700 can be employed to upload an image or images rising event information. The event-related upload display 700 can be used by event personnel, photography or videography personnel, event participants, and/or event spectators.

The event-related upload display 700 in some embodiments enables the user to specify the context, being aided by contextually relevant drop-down lists. The event-related upload display 700 in the embodiment shown includes an event type selector 712, a division selector 713, an image display area 716, a file select area 718, a URL select area 721, a caption entry area 724, and an upload selection area 727. The event type selector 712 presents a listing of events to be selected from when the user selects the arrow icon on the right side of the event type selector 712. The events can include matches (such as sparring or combat events, for example), presentations (board-breaking, forms, or other presentation events), or other event types. The user employs the event type selector 712 to select an appropriate event/event type from among the events presented by the event type selector 712. The division selector 713 presents a listing of divisions to be selected from when the user selects the arrow icon on the right side of the division selector 713. The user employs the division selector 713 to select an appropriate division from among the divisions presented by the division selector 713. The image viewing area 716 can display a thumbnail or small image as part of the upload process. Further, the image viewing area 716 can display a portion or all of a video in some embodiments. The image viewing area 716 can be consulted by the user to ensure that the user is uploading an image or images that the user intends to upload. The file select area 718 can be employed by the user to specify or select a file to be uploaded, such as by selecting a file from a list or by following a file tree to find a particular file. The URL select area 721 can be employed by the user to select a image or images by entering or selecting an appropriate URL (Uniform Resource Locator) or other link, address, or network information. The caption entry area 724 can be employed by the user to generate or enter a caption for the image or images being uploaded. The upload selection area 727 in the embodiment shown comprises a button, selection graphic, or other input area that can be employed by the user to finalize an image upload, such as when other items of information have been specified or completed.

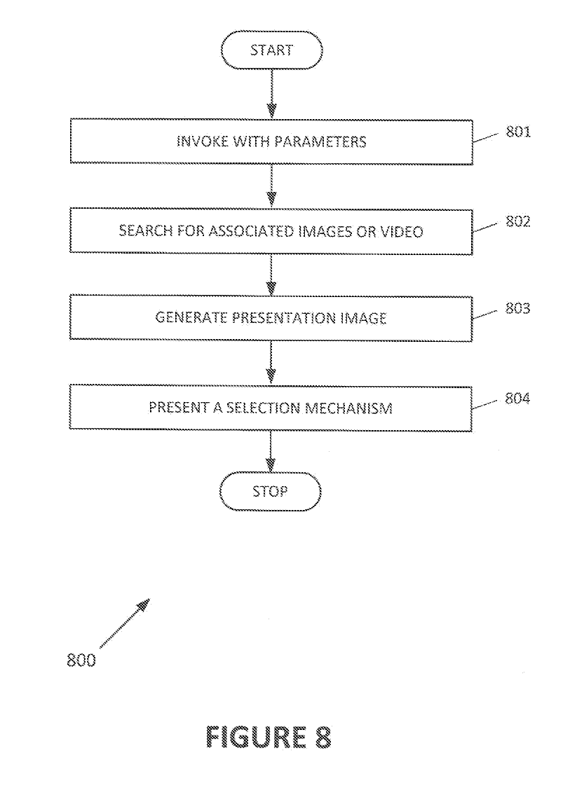

FIG. 8 is a flowchart 800 of a method for showing images in an image data of the image handling system. The image data can comprise an internal storage of the image handling system or can comprise an external database or storage. In step 801, an image showing process is invoked with parameters. The parameters comprise competitive event image parameters or competitive event parameters. The parameters in some examples comprise one or more of a competitive event ID, a division ID, or a match ID. However, it should be understood that other or additional parameters are contemplated and are within the scope of the description and claims.

In step 802, the image data is searched for images associated with the parameters. An image list is produced as a result of the search. The search can produce multiple single images, multiple images, single video, or multiple videos, for example. The search can further produce information including a primary location, a thumbnail image/proxy location, image captions, image types (e.g., image, audio, video), or other or additional information that can be used to retrieve images. The additional information can be included in or referenced by the produced image list.

In step 803, for each item in the produced image list, the method selects an image or images to present to the user. The selected image or images are employed by the user for selecting whether to view the real image or images. If the image data does not have a thumbnail image or proxy to display, then a primary image is displayed instead.

In step 804, a selection mechanism is presented for each image in the image list. The selection, mechanism can include the thumbnail, proxy, or real image, or can be presented along with the thumbnail, proxy, or real image. Alternatively, or in addition, a filename, title, or caption can be presented for the thumbnail proxy, or real image, or can be presented along with the thumbnail, proxy, or real image. A thumbnail or proxy can be used to minimize the required bandwidth, such as where the requesting user device is a user's cellphone or smartphone that has a low bandwidth or that invokes extra charges for higher bandwidth delivery. If the proxy is used, the proxy can represent a “play button” of a video, for example. The play button image also indicates that the corresponding image data is a video and not just an image.

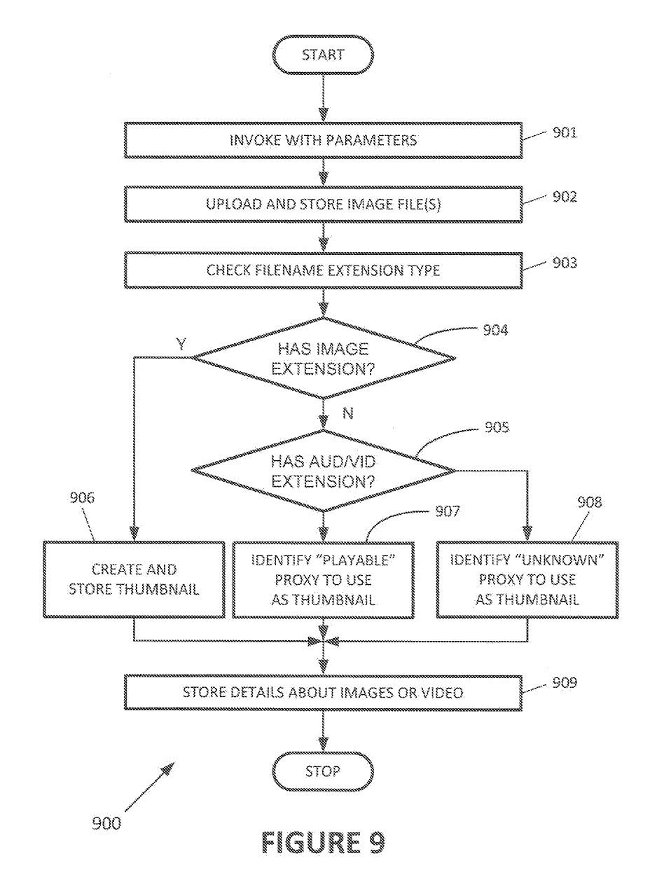

FIG. 9 is a flowchart 900 of a method for uploading images or videos from a user device, such as a user computer device. In step 901, an image uploading process is invoked with parameters. The parameters comprise competitive event image parameters or competitive event parameters, as previously discussed.

In step 902, the user device uploads and stores an image file or files to the image data of the image handling system. The image file or files can be stored using one or more of the invoking parameters, such as a competitive event ID, a division ID, a match ID, a file name, a caption, a title, or a combination thereof.

In step 903, the image handling system checks the filename extension type. A still image may have an expected filename extension type, such as .jpg, .bmp, .tff, while a video may have a different expected filename extension type, such as .mpg, mpg4, .avi format, for example.

In step 904, if the filename extension type is a still image filename extension type, the method branches to step 906. Otherwise, the method proceeds to step 905.

In step 905, if the filename extension type is an audio and/or video filename extension type, the method proceeds to step 907. Otherwise, the method branches to step 908.

In step 906, where the image file or files has a still image filename extension type, the method creates and stores an image thumbnail from the image file or files. The thumbnail comprises a smaller resolution and smaller size image that still visually represents the image file or files.

In step 906, where the image file or files has an audio/video image filename extension type, the method creates and stores a “playable” proxy to use as a thumbnail. The “playable” proxy can comprise any suitable image, icon, or graphic.

In step 908, where the image file or files does not have an identifiable image filename extension type, the method creates and stores an “unknown” proxy to use as a thumbnail. The “unknown” proxy can be actuated to select the image file or files or to initiate viewing or playback of the image file or files.

In step 909, the image handling system stores the image file or files, along with the generated thumbnail or proxy.

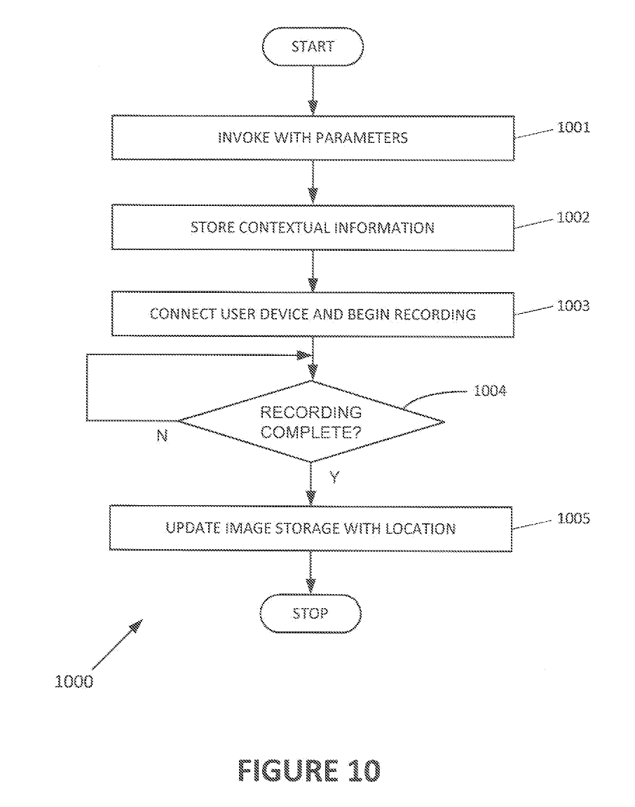

FIG. 10 is a flowchart 1000 of a method for uploading videos to the Internet. The uploading can include storing reference information for the videos in the image handling device, wherein the image handling device subsequently can access the uploaded videos. In step 1001, an image uploading process is invoked with parameters. The parameters comprise competitive event image parameters or competitive event parameters, as previously discussed.

In step 1002, contextual information for the image file or files is stored. The contextual information may be stored in the image data of the image handling system in some embodiments. A reference ID can accompany the image file or files, or can be generated by the image handling system. In addition, the contextual information may be uploaded with the videos to the Internet.

In step 1003, the user connects a user device to an interface and begins recording. The user device can upload the video to the Internet, and to a storage device accessible via the Internet (such as cloud storage or a video storage server). The user may or may not retain a locally-recorded or stored version of the video. Appropriate video start and end information can be stored along with the video.

In step 1004, if video recording is complete, the method proceeds to step 1005. Otherwise, the method branches back and continues recording.

In step 1005, where video recording is complete, the method updates the image storage with final information. The final information can include a reference ID and can include location information, wherein the image handling system stores the reference ID and the location information, wherein the image handling system can subsequently retrieve the stored video or can enable a user to find and retrieve the stored video.

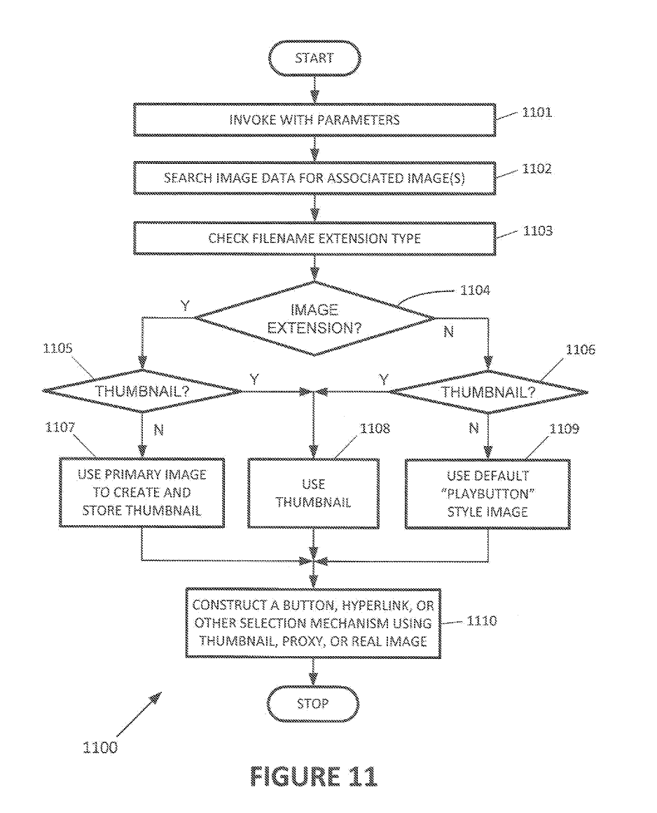

FIG. 11 is a flowchart 1100 of a method for showing videos stored by the image handling system. In step 1101, an image viewing process is invoked with parameters. The parameters comprise competitive event image parameters or competitive event parameters, as previously discussed.

In step 1102, the image handling device searches the image data using the invoking parameters. The searching may generate one or more image files.

In step 1103, the image handling system checks the filename extension type of the found image files. A still image may have an expected filename extension type, such as .jpg, .bmp, .tff while a video may have a different expected filename extension type, such as .mpg, .mpg4, .avi format, for example.

In step 1104, if the filename ex tension type is a still image filename extension type, the method branches to step 1105. Otherwise, the method proceeds to step 1106.

In step 1105, where the image file or files has a still image filename extension type, the method determines whether the image file has an associated thumbnail. If the image file has an associated thumbnail, the method proceeds to step 1107. Otherwise, the method branches to step 1108.

In step 1106, where the image file or files has an audio/video image filename extension type, the method determines whether the image file has an associated thumbnail. If the image file has an associated thumbnail, the method proceeds to step 1109. Otherwise, the method branches to step 1108.

In step 1107, where the image file has a still image filename extension type but no thumbnail, the method creates and stores a thumbnail from the primary image.

In step 1108, where the image file has an associated thumbnail, the method uses the thumbnail to create a selection mechanism.

In step 1109, where the image file has an audio/video image filename extension type but no thumbnail, the method creates and stores a default “playbutton” style image. The default “playbutton” style image can comprise a recognizable video playback button image, for example.

In step 1110, the method constructs a button, hyperlink, or other selection mechanism for showing videos. The selection mechanism can be constructed using the thumbnail from step 1107, the thumbnail from step 1108, or the default image created by step 1109. The user can select the selection mechanism to initiate viewing of the associated image file or flies.

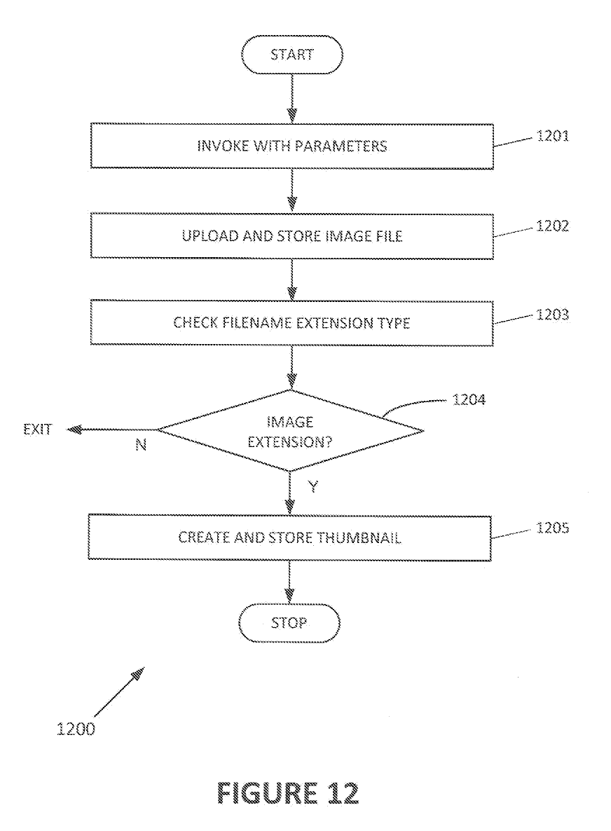

FIG. 12 is a flowchart 1200 of a method for uploading videos from a user's computer or computerized device. In step 1201, an image uploading process is invoked with parameters. The parameters comprise competitive event image parameters or competitive event parameters, as previously discussed.

In step 1202, an image file is uploaded and stored form the user's computer or computerized device. The user's device can comprise any manner of device, as previously discussed. The image file is uploaded and stored in the image data of the image handling system.

In step 1203, the image handling system checks the filename extension type of the uploaded image file.

In step 1204, if the filename extension type is an image filename extension type, the method proceeds to step 1205. Otherwise, the method exits.

In step 1205, the image handling system creates and stores a thumbnail for the uploaded image file. The thumbnail is stored with (or associated with) the uploaded image file. The thumbnail can subsequently be used in searching the image data of the image handling file.

I claim:

1. An image-handling system for receiving and distributing images of a competitive event, the system comprising:
a storage system storing an image-handling routine, image data, and image mapping information; and
a processing system coupled to the storage system, wherein the processing system when executing the image-handling routine is configured to:
receive and store images in the image data of the storage system;
generate and store image mappings in the image mapping information of the storage system, with the image mappings correlating a particular image or images to a particular portion or portions of the competitive event; and
recall a image or images from the image data based on a received image request received from a requester; and
transfer the requested image or images to the requester.

2. The image-handling system of claim 1, with the image data comprising still photographs and videos.

3. The image-handling system of claim 1, with the image mapping correlating the particular image or images to one or more of a particular match or presentation of the competitive event, a particular weight class of the competitive event, a particular age class of the competitive event, a gender of the competitive event, a particular skill level of the competitive event, a particular bracket of the competitive event, or a particular division of the competitive event.

4. The image-handling system of claim 1, with the processing system being further configured to perform an image format conversion on a received or requested image or images.

5. The image-handling system of claim 1, with the processing system being further configured to adjust image size or image characteristics of a received or requested image or images.

6. The image-handling system of claim 1, with the processing system being further configured to perform image enhancement on a received or requested image or images.

7. The image-handling system of claim 1, with the processing system being further configured to perform compression on a received or requested image or images.

8. The image-handling system of claim 1, with the storage system storing event information related to the competitive event, wherein the processing system is further configured to recall the image or images from the image data based on the received image request and based on the event information.

9. The image-handling system of claim 1, with the processing system being further configured to request and accept images from one or more of event personnel, event participants, and event spectators.

10. The image-handling system of claim 1, with the processing system being further configured to perform one or both of organizing the image data or indexing the image data.

11. The image-handling system of claim 1, with the processing system big further configured to generate the image mappings using image mapping information that maps the image data based on predetermined relationships with event participants.

12. The image-handling system of claim 1, with the processing system being further configured to generate the image mappings using image mapping information that maps the image data based on one or more of a club affiliation, organization affiliation, state represented, or country represented by a participant.

13. An image-handling method for receiving and distributing images of a competitive event, the method comprising:
an image handling system receiving and storing images in image data of a storage system;
the image handling system generating and storing image mappings in image mapping information of the storage system, with the image mappings correlating a particular image or images to a particular portion or portions of the competitive event; and
the image handling system recalling an image or images from the image data based on a received image request received from a requester; and
the image handling system transferring the requested image or images to the requester.

14. The method of claim 11, with the image data comprising still photographs and videos.

15. The method of claim 11, with the image mapping correlating the particular image or images to one or more of a particular match or presentation of the competitive event, a particular weight class of the competitive event, a particular age class of the competitive event, a gender of the competitive event, a particular skill level of the competitive event, a particular bracket of the competitive event, or a particular division of the competitive event.

16. The method of claim 11, further comprising performing an image format conversion on a received or requested image or images.

17. The method of claim 11, further comprising adjusting image size or image characteristics of a received or requested image or images.

18. The method of claim 11, further comprising performing image enhancement on a received or requested image or images.

19. The method of claim 11, further comprising performing compression on a received or requested image or images.

20. The method of claim 11, further comprising the storage system storing event information related to the competitive event, wherein the processing system is further configured to recall the image or images from the image data based on the received image request and based on the event information.

21. The method of claim 11, further comprising the image handling system requesting and accepting images from one or more of event personnel, event participants, and event spectators.

22. The method of claim 11, with the processing system being further configured to perform one or both of organizing the image data or indexing the image data.

23. The method of claim 11, with the processing system big further configured to generate the image mappings using image mapping information that maps the image data based on predetermined relationships with event participants.

24. The method of claim 11, with the processing system being further configured to generate the image mappings using image mapping information that maps the image data based on one or more of a club affiliation, organization affiliation, state represented, or country represented by a participant.
